(19) United States
(12) Patent Application Publication
(10) Pub. No.: US 2026/0208657 A1
(43) Pub. Date: Jul. 23, 2026

(54) FUEL TRANSPORT VEHICLE WITH A PUMPING AND DISPENSING MODULE

(71) Applicant: ND Defense LLC, Madison Heights, MI (US)

(72) Inventors: Philip Wiegand, Washington, MI (US); Michael Philip McGovern, Clarkston, MI (US); David Paul Zink, Shelby Township, MI (US)

(73) Assignee: ND Defense LLC, Madison Heights, MI (US)

(21) Appl. No.: 19/450,242

(22) Filed: Jan. 15, 2026

Related U.S. Application Data
(60) Provisional application No. 63/746,641, filed on Jan. 17, 2025.

(51) Int. Cl. B60P 3/22; B67D 7/04

(52) U.S. Cl. CPC B60P 3/2245; B60P 3/221; B60P 3/225; B60P 3/2265; B67D 7/04

(57) ABSTRACT

A fuel transport vehicle for dispensing fuel includes a tank for carrying fuel mounted to a trailer. A coupling apparatus located on a first end of the trailer removably couples the trailer to a tractor for transporting the trailer. A second end of the trailer includes a detachably mounted pumping and dispensing module arranged to pump and dispense fuel from the tank while mounted to the fuel transport vehicle or, dismounted to dispense fuel from fuel storage tanks located at a dispensing site. A control panel mounted to the trailer is arranged to send control signals to the pumping and dispensing module for operating module to dispense fuel.

### CROSS-REFERENCE TO RELATED APPLICATION AND PRIORITY CLAIM

This application claims priority under 35 U.S.C. § 119(e) to U.S. Provisional Patent Application No. 63/746.641 filed on January 17, 2025. This provisional application is hereby incorporated by reference in its entirety.

### TECHNICAL FIELD

This disclosure is generally directed to a fuel transport vehicle and more particularly to a fuel transport vehicle that incorporates a modular pumping and dispensing module that can dispense fuel mounted to the fuel transport vehicle or dismounted from the fuel transport vehicle.

### BACKGROUND

Fuel transport vehicles include fuel delivery trucks with large integrated fuel tanks which utilize integrated pumps to refuel other vehicles or fuel storage tanks. These include, for example, a trailer having an integrated fuel tank and a pumping system for dispensing the fuel from the integrated fuel tank. The trailer and pumping system must be hauled to a dispensing site by an engine driven tractor having a driver’s cab and set up as a temporary refueling station for vehicles at the dispensing site. Further examples can include ground support equipment used for refueling aircraft at fixed locations, such as airfields, or at temporary remote locations used as forward operating areas. Presently known pumping and dispensing systems, even though movable, are not truly portable as they cannot be independently removed or dismounted from their transport vehicle, to dispense fuel from other fuel storage tanks that may be located above ground or below ground at a dispensing site.

Accordingly, the present disclosure describes a fuel transport vehicle that can be driven to a dispensing site that incorporates a modular pumping and dispensing module that can be operated mounted to the fuel transport vehicle to dispense fuel from an integrated fuel tank or dismounted from the fuel delivery vehicle to dispense fuel from fuel storage tanks located at the dispensing site.

### SUMMARY

This disclosure relates to a fuel transport vehicle that incorporates a modular pumping and dispensing module that can dispense fuel mounted to the fuel transport vehicle or dismounted from the fuel transport vehicle.

In a first aspect of the disclosure, a fuel transport vehicle is disclosed comprising a tank for carrying fuel mounted to the vehicle. A driver cab is located at a first end of the tank, and a pumping and dispensing module is detachably mounted on a second end of the tank for dispensing the fuel from the tank.

In a second aspect of the disclosure, a fuel transport vehicle for dispensing fuel is disclosed comprising a tank for carrying fuel mounted to a trailer having a coupling apparatus located on a first end of trailer for removably coupling the trailer to a tractor for transporting the trailer. A second end of the trailer includes a detachably mounted frame containing a pumping and dispensing module for pumping and dispensing the fuel from the tank. A control panel mounted to the trailer is arranged to send control signals to the pumping and dispensing module for operating module to dispense the fuel from the tank.

In a third aspect of the disclosure, a transport vehicle for dispensing fuel to refuel at least one vehicle and at least one fuel storage tank located in a staging area is disclosed comprising a tank for carrying fuel mounted to a trailer. A coupling apparatus located on a first end of the trailer couples the trailer to a tractor for transporting the trailer to the staging area. A pumping and dispensing module contained in a frame is detachable and removable from a second end of the trailer. The pumping and dispensing module is arranged to dispense the fuel from the tank when the frame is removed from the trailer and placed adjacent to the staging area at a location remote from the trailer.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 is a perspective view of the fuel transport vehicle;

FIG. 2 is a rear perspective view of the trailer of the fuel transport vehicle;

FIG. 3 is a rear elevational view of trailer of the fuel transport vehicle;

FIG. 4 is a perspective view of the modular pumping dispensing module;

FIG. 5 is a perspective view of the modular pumping dispensing module removed from its frame; and

FIG. 6 is a perspective view of the modular pumping dispensing module having armor plate attached to the modular pumping dispensing module.

### DETAILED DESCRIPTION

The figures discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

The preferred embodiment of the present disclosure is directed to a fuel transport vehicle that delivers fuel to vehicles outside of a specialized fueling station environment, and that includes a modular pumping and dispensing module that can be operated mounted to the fuel transport vehicle to dispense fuel from an integrated fuel tank or dismounted from the fuel transport vehicle to dispense fuel from fuel storage tanks located at a dispensing site.

The fuel transport vehicle comprises a wheeled trailer having a fuel storage tank integrally mounted to the trailer. A first end of the trailer includes a coupling apparatus for attaching the trailer to an engine driven wheeled tractor having a driver’s cab. The tractor, when coupled to the trailer with the coupling apparatus, is used to transport the trailer to the dispensing site. A modular pumping and dispensing module is stowable on a second end of the trailer and is communicatively connected to a control panel located on the trailer. The modular pumping and dispensing module is operable by an operator/driver using the control panel to dispense fuel at the dispensing site from the integrated fuel tank when the modular pumping and dispensing module is mounted on the trailer. The modular pumping and dispensing module is also arranged to be disconnected from the integrated fuel tank and dismounted from the trailer and placed on the ground, wherein the modular pumping and dispensing module may be fluidically connected to fuel storage tanks located above or below ground at the dispensing site. The dismounted modular pumping and dispensing module is connected to the control panel by an electrical cable and operable by the operator/driver to dispense fuel from connected storage tanks. In preferred embodiments the fuel is a liquid fuel selected from the group of fuels including gasoline, diesel, ethanol, kerosene, and jet A fuels.

The modular pumping and dispensing module includes a pumping system that includes pumps, valves, meters, ancillary piping, and equipment to enable transfer of fuel from the integrated fuel storage tank to the hoses, reels and nozzles of a dispensing system for the safe and efficient delivery of fuel to recipient vehicles and to fuel storage tanks at the dispensing site.

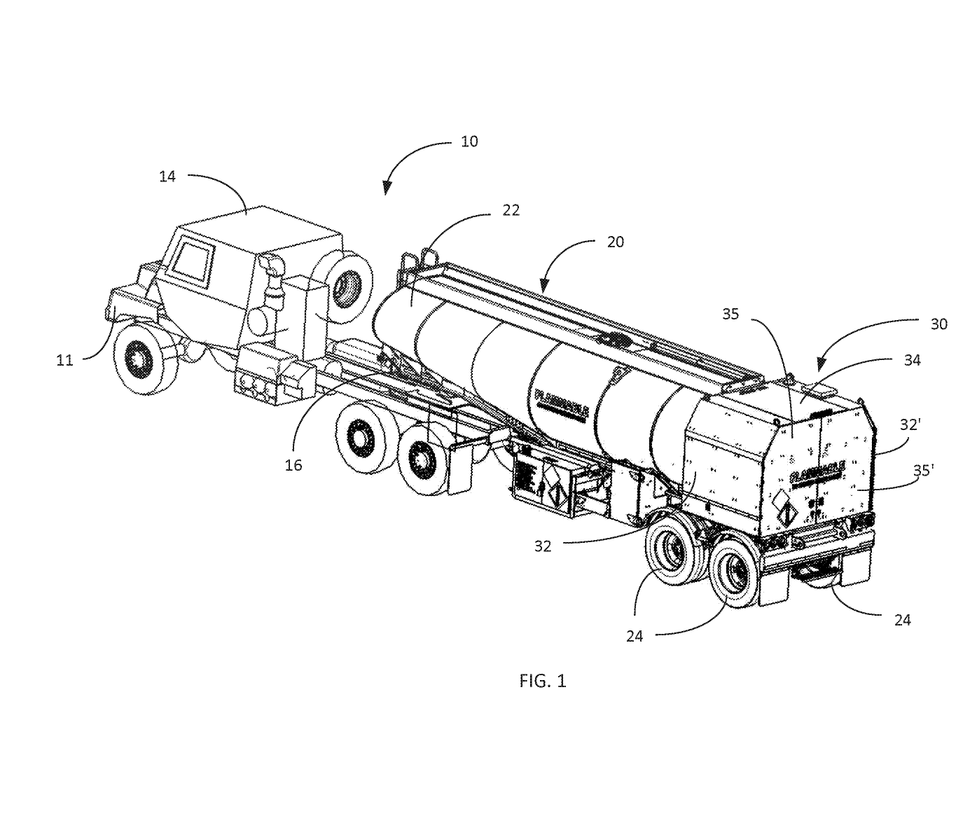

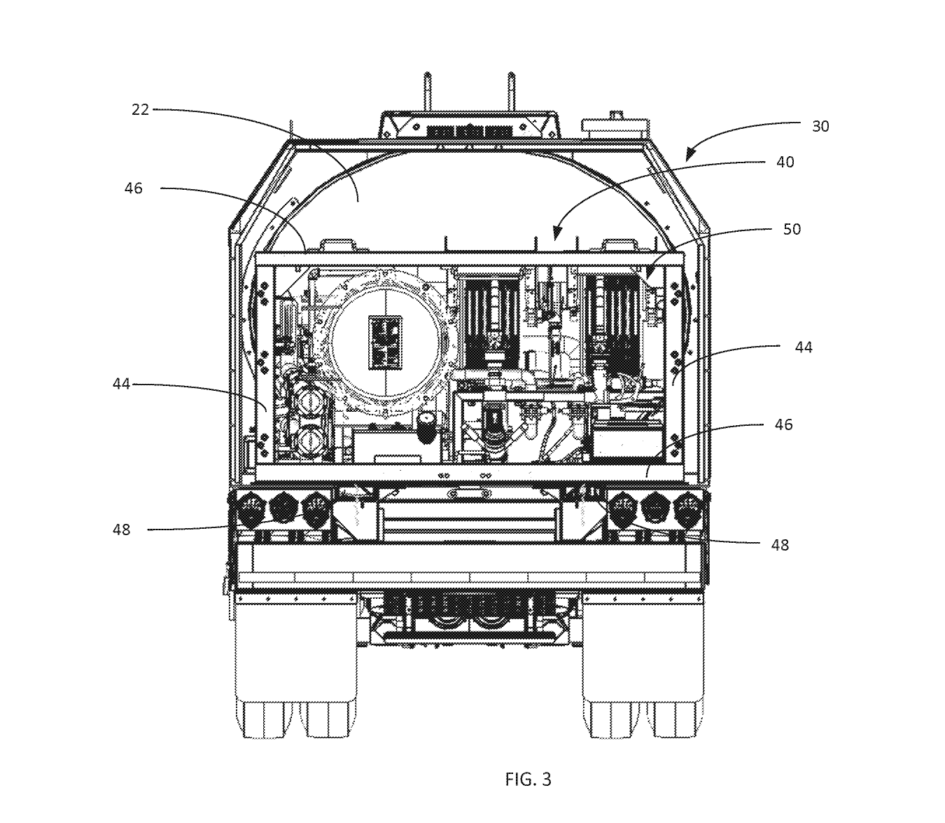

Referring to FIGS. 1-4 a preferred embodiment of an exemplary fuel transport vehicle 10 is illustrated. The fuel transport vehicle 10 comprises an engine driven tractor 11 with a driver’s cab 14 and a wheeled trailer 20 arranged to be coupled to each other via a coupling apparatus 16 located on a rear portion of the tractor 11 and on a first end of the wheeled trailer 20. The operator/driver of vehicle 10 can operate the coupling apparatus 16 to connect or alternately disconnect tractor 11 from trailer 20. Trailer 20 includes an integrated fuel storage tank 22 located on trailer 20 having a sufficient capacity to carry approximately 5,000 gallons of fuel or any larger or smaller quantity, as may be required. At least two axles are mounted transversely on trailer 20 at a second end of trailer 20, opposite the first end and the coupling apparatus 16. Each axle is coupled to wheel assemblies 24 having rubber tires or the like. Trailer 20 is towable behind the tractor 11 when the tractor is coupled to the trailer. In other embodiments the first end of the trailer may be configured to include an engine driven cab 14 that is fixed to and integrated with the trailer 20 (not show).

Enclosure 30 is located on the second end of trailer 20 above the wheel assemblies 24. Enclosure 30 is configured as a box structure, having at least first and second side walls 32, 32’, a back panel (not shown), a roof panel 34, and a set of double doors 35 and 35’. The floor of the enclosure 30 comprises a top surface of the trailer floor 36. Each door 35, 35’ is fixed to a respective one of the first and second side walls 32, 32’ by hinges 38, 38’. The hinges 38, 38’ allow each door 32, 32’ to swing outward toward the rear of the trailer 20 and provide access to the interior of enclosure 30.

Housed within enclosure 30 is a removable rectangular frame 40 comprised of a solid planar platform 42, four vertical L-shaped column frame members 44 extending from each corner of platform 42 and four L- shaped horizontal beam frame members 46 that are fixed to the ends of the column members 44. The columns 44 and beam frame members 46 form a rectangular open sided box. A set of rectangular c-type channel members 48 are fixed to a bottom surface of platform 42. The channel members 48 are located parallel to each other and extend substantially fore and aft along the bottom surface of platform 42.

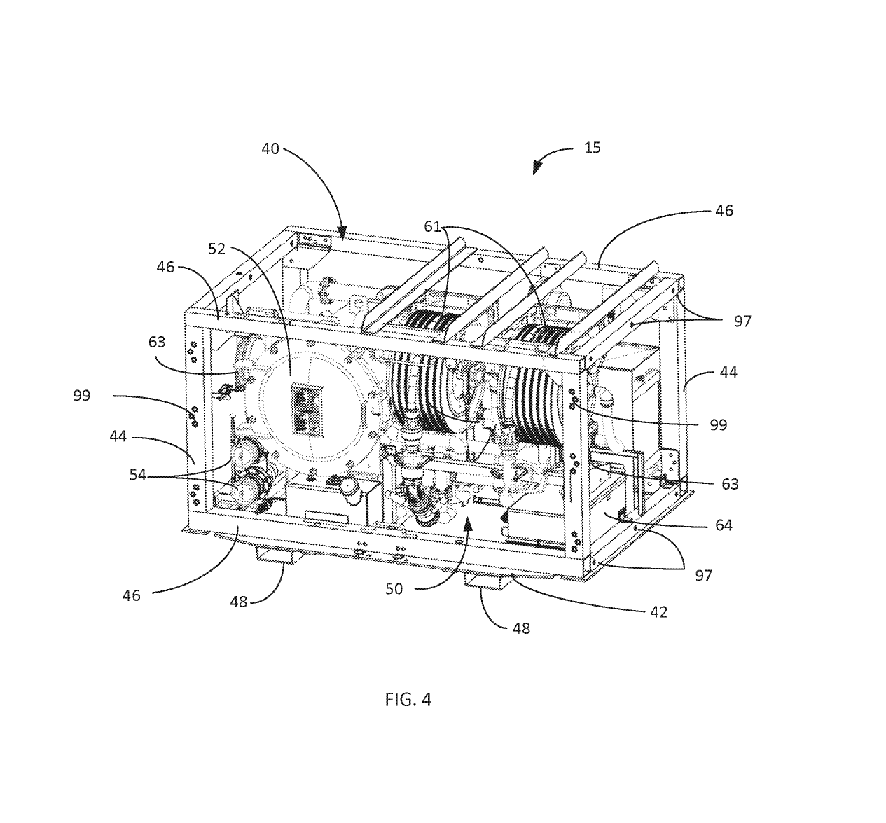

As illustrated in FIG. 4, frame 40 is arranged to accept and contain entirely within frame 40 the components and equipment used to pump and dispense fuel 50, that together with frame 40, comprise the modular pumping and dispensing module 15. The components and equipment for pumping and dispensing fuel 50 may include, but not limited to, a pumping system comprising an engine, a fuel tank for providing a source of fuel to the engine, a fluid pump driven by the engine, and flow meters. The pumping system may further include a filter and separator 52, bulk delivery and bulk loading fittings 54, and valves and any associated piping required to transfer fuel from the fuel storage tank 22 to the pumping system and subsequently to the components and equipment for pumping and dispensing fuel 50.

The components and equipment for pumping and dispensing fuel 50 may further include one or two 50-foot dispensing hoses 61 on hose reels with electric rewind mechanisms and nozzles comprising a dispensing system for dispensing of fuel provided by the pumping system. For example, each hose real may have a hose 61 arranged to dispense fuel using a nozzle end that would allow fueling using a pressure-feed system or a gravity-feed system. The dispensing system may also contain a pair of reels 63 on either side of the frame 40 having a length of grounding wire for grounding the pumping and dispensing system during operation. A battery box 64 contains a battery for providing ignition power to the pumping system engine and/or electrical power to a control panel 72 and the valve actuators. Electrical power may be used to actuate fuel transfer valves responsive to control signals sent from the control panel 72.

All the components and equipment used to pump and dispense fuel 50 are contained within frame 40 and are mounted to frame columns 44, beams 46 or to the frame platform 42 in any convenient method known for attaching such components to structural members. The frame 40 with the mounted pumping and dispensing components and equipment 50 are arranged to be stowed and mounted within the enclosure by resting the C-type channels 48 on the top surface of the trailer floor 36 within the enclosure 30 interior and fastening the frame platform 42 to the trailer floor 36. With the frame 40 stowed within the enclosure 30 the double doors 35, 35’ can be closed by enclosing the modular pumping and dispensing module 15 within the enclosure 30 thereby protecting it when the transport vehicle is driven to a dispensing site.

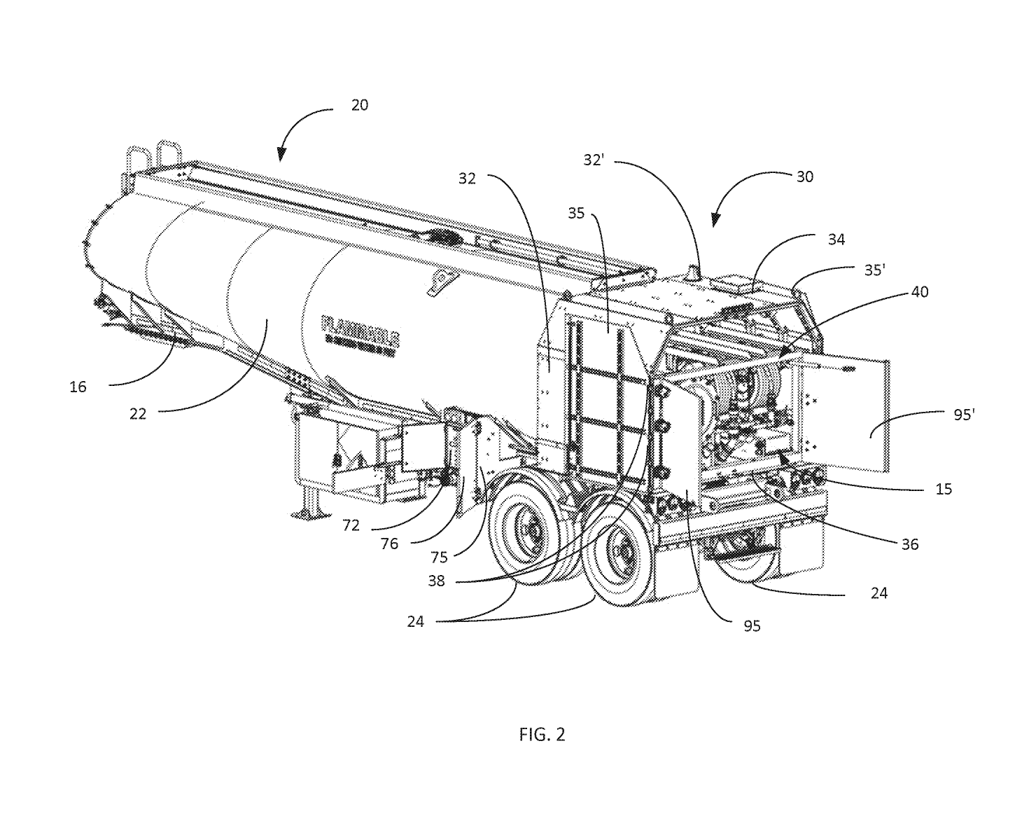

As best seen at FIG. 2, the control panel 72 is located on the driver/operator side of trailer 20 contained within an enclosure 75 and accessed through door 76. The control panel 72 and may include electrical circuits for the measurement and control of the components and equipment for pumping and dispensing fuel 50. The control circuits contained in the control panel 72 may control the pump engine, fluid pump, the flow meters, and valves of the pumping system. The control panel may selectively connect the battery in battery box 64 to the pump control circuits and the valve actuators associated with the modular pumping and dispensing module 15 to control the flow of fuel from a storage tank to the components and equipment for pumping and dispensing fuel 50. Data lines from the flow meters may connect to respective registers. The flow meters may transmit flow measurement data pulses to their respective registers. In some embodiments the flow meter may be analog devices. In some embodiments the flow meters may be digital devices. In some embodiments the flow meters may include an integral display located on the control panel 72. Flow measurement data including total delivery volume is transmitted from the flow meters to the control panel 72 where it can be presented on a display to the operator/driver of the fuel transport vehicle or stored for future use.

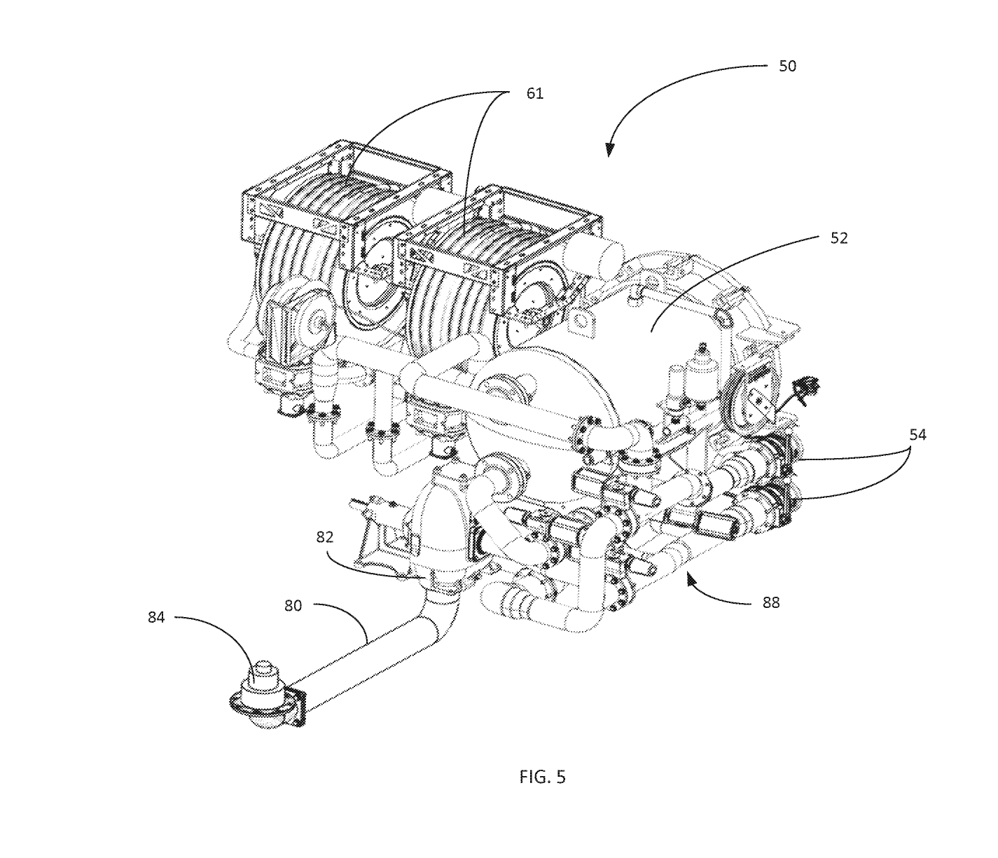

With reference to FIG. 5, a fuel feed pipe 80 from the modular pumping and dispensing module 15 is connected to a valve coupling 84 on a first end of pipe 80 that is fluidically connected to the bottom of the integrated fuel storage tank 22 of trailer 20. Pipe 80 allows the pumping and dispensing module to draw fuel from the storage tank 22. A second end of the pipe 80 is removably connected to a fluid coupling 82 on the modular pumping and dispensing module 15. The fluid coupling 82 may include any convenient method for removably attaching pipe 80 to fluid coupling 82. Such as for example, a flange secured with fasteners (not shown). The fasteners arranged to be removable to uncouple the pipe 80 from the modular pumping and dispensing module. The fuel feed pipe 80 may also be used with the bulk delivery and bulk feed fittings 54 to fill or dispense fuel from the fuel storage tank 22, using associated valves and piping 88 that when selected by the control panel 72, fluidically connect fuel hoses attached to fittings 54 to pipe 80. Filtered or unfiltered fuel can be loaded and dispensed from the bulk feed fittings 54 by setting the appropriate valves and piping 88 using the control panel 72.

At a dispensing site, the fuel transport vehicle 10 may be parked near a vehicle to be refueled or to fuel storage tanks that may require to be filled. Tractor 11 may be uncoupled from trailer 20 or left coupled if the trailer 20 is to be moved after refueling is completed. With the modular pumping and dispensing module 15 mounted within enclosure 30, the modular pumping and dispensing module 15 is accessed by opening the enclosure double doors 35, 35’. The appropriate hose 61 from a hose real is deployed to a filing port on the vehicle or fuel storage tank to be refueled and the operator/driver selects fueling controls on the control panel 72 to start the pumping engine and pump and set the valves to provide fuel from the integrated storage tank 22 to the dispensing hose 61 and to the vehicle being refueled.

When refueling is completed, the control panel 72 sends control signals based on the operator/driver selections to terminate fueling, that shuts off the pumping engine and pump and closes the actuated valves. The deployed hose 61 is then retracted into its associated hose reel. Fuel transport vehicle 10 may remain at the dispensing site with doors 35, 35’ of enclosure 30 open ready to fuel another vehicle, or the doors 35, 35’ closed and the fuel transport vehicle 10 driven away by the driver/operator to another dispensing site.

At certain dispensing sites, above ground and/or below ground fuel storage tanks (not shown) may be available for use to refuel vehicles. Such as for example, aircraft or ground vehicles, including support equipment that are deployed and used at a forward operating area. In such a situation, the modular pumping and dispensing module can be dismounted from trailer 20 and placed on a platform or on the ground away from trailer 20 to use the fuel storage tanks available at the operating area. At such sites, the modular pumping and dispensing module 15 is dismounted from the trailer by removing the fasteners securing the frame platform 42 to the trailer floor 36 and the pipe 80 removed and disconnected from fluid coupling 82. The modular pumping and dispensing module can now be lifted and moved from enclosure 30 using a support vehicle, such as for example a forklift. The forks of the forklift are inserted into C-channels 48 and the forklift operated to lift and extract the frame containing the modular pumping and dispensing module from the rear of the trailer through double doors 35, 35’. The modular pumping and dispensing module 15 can then be placed on the ground or on a platform and the forklift removed. An electrical umbilical cord (not shown) can be electrically connected from the control panel 72 to a junction box on the frame coupled to the components and equipment used to pump and dispense fuel 50 that provide control signals from the control panel 72 to operate the components and equipment 50 of modular pumping and dispensing module 15. Fuel feed hoses or pipes from the above or below ground storage tanks are next coupled to the pumping system using bulk feed fittings 54.

The modular pumping and dispensing module 15 can now be used to dispense fuel dismounted from trailer 20, operated by control panel 72 to send control signals to the components and equipment 50 of modular pumping and dispensing module 15. Each dispensing hose 61 may be deployed to fuel ground vehicles or aircraft while dismounted from the trailer 20 to fuel ground vehicles or aircraft using the fuel storage tanks located at the forward operating area.

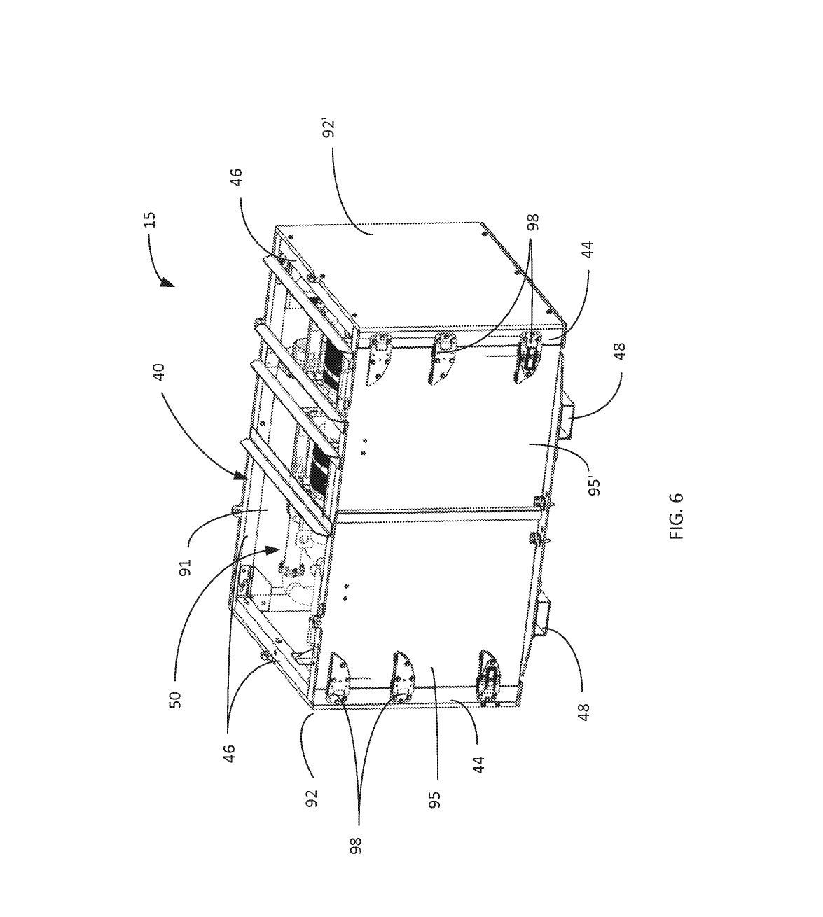

In certain situations, and conditions, the modular pumping and dispensing module when dismounted from the trailer may require to be protected from being damaged from hostile acts. FIG. 6 illustrates frame 40 having armor plating attached to columns 44 and beams 46. Frame 40 may include a plurality of holes 97 at locations along the columns 44 and beams 46 allowing the use of fastening devices to attach armor plate on the frame 40 to protect the pumping and dispensing components 50 of the module 15. The armor plate may include first and second armored side walls 92, 92’, and an armored back wall 91. The front of the module may include a set of armored double doors 95, 95’ on hinges 98 attached to holes 99 using fastening devices that allow doors 95, 95’ to swing outward to allow access to the pumping and dispensing components 50. The armor may be attached to frame 40 after the modular pumping and dispensing module 15 is dismounted from the trailer 20 to be protected from being damaged from hostile acts while dismounted. The frame 40 may also be transported with the armor plate attached and mounted within enclosure 30 to protect the modular pumping and dispensing module from damage while being transported on trailer 20.

It may be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” or “controller” within a claim is understood and intended to refer to structures known to those skilled in the relevant art, as further modified or enhanced by the features of the claims themselves and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A fuel transport vehicle for dispensing fuel comprising:
a tank for carrying fuel mounted to the vehicle;
a driver cab located at a first end of the tank; and
a pumping and dispensing module detachably mounted on a second end of the tank for dispensing the fuel from the tank.

2. The fuel transport vehicle of claim 1, wherein the tank is mounted to a trailer and further comprises a coupling apparatus located at the first end of the tank for coupling the trailer to a tractor comprising the driver cab.

3. The fuel transport vehicle of claim 2, wherein the trailer includes a control panel mounted to the trailer, the control panel arranged to send control signals for operating the pumping and dispensing module.

4. The fuel transport vehicle of claim 2, wherein the pumping and dispensing module includes a frame that is housed in an enclosure when mounted on the trailer.

5. The fuel transport vehicle of claim 4, wherein the enclosure includes at least one door that provides access to the pumping and dispensing module.

6. The fuel transport vehicle of claim 2, wherein the pumping and dispensing module includes a fuel inlet removably connected to a tank fuel outlet.

7. The fuel transport vehicle of claim 6, wherein fuel from the tank fuel outlet is transferred to the pump and dispensing module and dispensed in accordance with control signals from the control panel when the pump and dispensing module is mounted on the trailer.

8. The fuel transport vehicle of claim 6, wherein the frame includes fastening devices arranged to fix the frame to the trailer and the fuel inlet to the tank fuel outlet.

9. The fuel transport vehicle of claim 8, wherein the fastening devices are arranged to be detached from the frame and the fuel inlet allowing the frame to be removed from the trailer and placed in a location remote from the trailer.

10. The fuel transport vehicle of claim 9, wherein the frame is arranged to have armor plating detachably secured to the frame for protecting the pumping and dispensing module.

11. The fuel transport vehicle of claim 10, wherein the armor plating includes at least one door that provides access to the pumping and dispensing module.

12. The fuel transport vehicle of claim 9, wherein the pumping and dispensing module includes an electrical umbilical cord connecting the pump and dispensing module to the control panel and the control signals when the pump and dispensing module is located remotely from the trailer.

13. The fuel transport vehicle of claim 11, wherein the pumping and dispensing module includes a fuel feed hose connecting the pump and dispensing module fuel inlet to the tank fuel outlet when the pump and dispensing module is located remotely from the trailer.

14. The fuel transport vehicle of claim 12, wherein the pumping and dispensing module fuel feed hose connects the pump and dispensing module fuel inlet to a fuel storage tank remotely located from the trailer.

15. The fuel transport vehicle of claim 4, wherein the frame includes a first dispensing hose mounted to the frame for dispensing fuel arranged to use either a pressure-feed system or a gravity-feed system.

16. The fuel transport vehicle of claim 1, wherein the frame includes a second dispensing hose mounted to the frame for dispensing fuel arranged to use either a gravity-feed system or a pressure-feed system.

17. A fuel transport vehicle for dispensing fuel comprising:
a tank for carrying fuel mounted to a trailer;
a coupling apparatus located on a first end of the trailer for coupling the trailer to a tractor for transporting the trailer;
a frame detachably mounted on a second end of the trailer containing a pumping and dispensing module for pumping and dispensing the fuel from the tank.

18. The fuel transport vehicle of claim 17, wherein the fuel transport vehicle further includes a control panel for sending control signals for operating the pumping and dispensing module to dispense the fuel.

19. A transport vehicle for dispensing fuel to refuel at least one vehicle and at least one fuel storage tank located in a staging area comprising:
a tank for carrying fuel mounted to a trailer;
a coupling apparatus located on a first end of the trailer for coupling the trailer to a tractor for transporting the trailer to the staging area;
a pumping and dispensing module contained in a frame detachable and removable from a second end of the trailer, arranged to dispense the fuel from the tank when the frame is removed from the trailer and placed adjacent the staging area at a location remote from the trailer.

20. The transport vehicle of claim 19, wherein the pumping and dispensing module is arranged to fluidically connect to the at least one fuel storage tank when the frame is removed from the trailer to refuel the at least one vehicle from the fuel storage tank.
